(19) United States
(12) Patent Application Publication
(10) Pub. No.: US 2013/0035462 A1
(43) Pub. Date: Feb. 7, 2013

(54) ETHYLENIC POLYMERIZATION CATALYST AND METHOD FOR MANUFACTURING ETHYLENIC POLYMER

(71) Applicants: Akihiko Ishi, Saitama (JP); Norio Nakata, Saitama (JP); Tomoyuki Toda, Saitama (JP)

(72) Inventors: Akihiko Ishi, Saitama (JP); Norio Nakata, Saitama (JP); Tomoyuki Toda, Saitama (JP)

(73) Assignees: SUMITOMO CHEMICAL COMPANY, LIMITED, Chuo-ku, Tokyo (JP); NATIONAL UNIVERSITY CORPORATION SAITAMA UNIVERSITY, Saitama-shi, Saitama (JP)

(21) Appl. No.: 13/577,952

(22) PCT Filed: Feb. 10, 2011
(86) PCT No.: PCT/JP2011/052938

§ 371 Date: Oct. 19, 2012

(30) Foreign Application Priority Data
Feb. 12, 2010 (JP) 2010-029191

(51) Int. Cl. C08F 4/76; C08F 4/659; C07F 7/00

(52) U.S. Cl. 526/170; 556/52; 502/117; 502/152

(57) ABSTRACT

A catalyst for homopolymerization of ethylene or copolymerization of ethylene and an α-olefin comprises a complex represented by Formula (1):

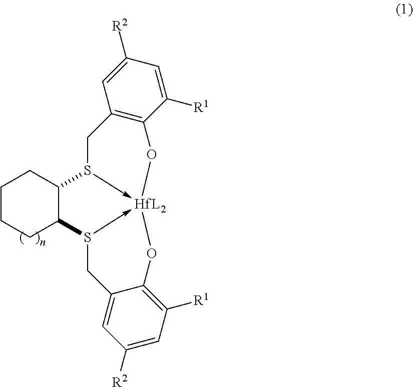

wherein n is 2 or 3; R¹ and R² are independently an optionally substituted alkyl group or a halogen atom; L is a ligand represented by CH₂R³, a halogen atom, OR⁴, or NR⁵R⁶; R³ is a hydrogen atom, an aromatic group, or a trialkylsilyl group; R⁴ is a lower alkyl group having 1 to 6 carbon atoms; and R⁵ and R⁶ are independently a hydrogen atom or a lower alkyl group having 1 to 6 carbon atoms. A method for manufacturing an ethylenic polymer involves homopolymerization of ethylene or copolymerization of ethylene and an α-olefin in the presence of the catalyst. The present invention provides a highly active tetradentate post-metallocene complex for ethylenic polymerization and a method for manufacturing the ethylenic polymer using the catalyst containing the complex.

### CROSS-REFERENCE TO RELATED APPLICATIONS

This application claims priority to Japanese Patent Application No. 2010-029191 filed on Feb. 12, 2010 and the entire of which is incorporated herein by reference.

### TECHNICAL FIELD

The present invention relates to a catalyst for homopolymerization of ethylene or copolymerization of ethylene and an α-olefin comprising a hafnium complex and a manufacturing method of a homopolymer of ethylene or a copolymer of ethylene and an α-olefin.

### BACKGROUND ART

In olefin polymerization chemistry which has made significant progress in the wake of a highly active magnesium-supported titanium catalyst of a Ziegler-Natta type, the development of metallocene catalysts is one of the recent topics. Recently, development of so-called post-metallocene catalysts has attracted attention for catalysts to build a more precise polymerization process.

In 2000, Kol et al. developed a zirconium complex having C₂ symmetry using a tetradentate ligand having a phenoxy group and a nitrogen atom and having high affinity for group IV metal elements, and reported a 1-hexene polymerization reaction catalyzed by this compound (Non-patent Literatures 1 to 3). Furthermore, Kol (Non-patent Literature 4) and Okuda et al. in Germany (Non-patent Literatures 5 and 6) synthesized group IV metal complexes using a ligand that contains sulfur atoms in place of the nitrogen atoms in the tetradentate ligand in an attempt to achieve a-olefin stereoselective polymerization.

Patent Literature 1 discloses polymerization of propylene with a diphenoxytitanium, diphenoxyzirconium, or diphenoxyhafnium complex derived from ethane-1,2-dithiol.

The present inventors have reported diphenoxytitanium, diphenoxyzirconium, and diphenoxyhafnium complexes derived from trans-cyclooctane-1,2-dithiol (Non-Patent Literature 7), and polymerization of 1-hexene with the zirconium complex, as a catalyst, among these complexes (Non-Patent Literature 8).

### CITATION LIST

### Non-Patent Literature

Non-Patent Literature 1: Journal of American Chemical Society, 2000, Volume 122, 10706-10707

Non-Patent Literature 2: Journal of American Chemical Society, 2006, Volume 128, 13062-13063

NON-PATENT LITERATURE 3: Journal of American Chemical Society, 2008, Volume 130, 2144-2145

NON-PATENT LITERATURE 4: Inorganic Chemistry, 2007, Volume 46, 8114-8116

NON-PATENT LITERATURE 5: Journal of American Chemical Society, 2003, Volume 125, 4964-4965

NON-PATENT LITERATURE 6: Angewandte Chemie International Edition, 2007, Volume 46, 4790-4793

NON-PATENT LITERATURE 7: Toda et al. Dai 58 Kai Sakutai Kagaku Touronkai, Kouen Youshishu (Abstract of the 58th Japan Society of Coordination Chemistry Symposium) 1Ab-07, Sep. 20, 2008

NON-PATENT LITERATURE 8: Journal of American Chemical Society, 2009, Volume 131, 13566-13567

### Patent Literature

Patent Literature 1: WO2007/075299

The entire contents of Patent Literature 1 and NON-PATENT LITERATUREs 1 to 8 are incorporated herein particularly by reference.

### SUMMARY OF THE INVENTION

### Problems to be Solved by the Invention

An object of the present invention is to provide a highly active tetradentate post-metallocene complex for an ethylenic polymerization and a method for manufacturing the ethylenic polymer using a catalyst containing the complex.

### Means for Solving Problem

According to the present invention, a highly active ethylenic polymerization catalyst is provided by the use of a diphenoxyhafnium complex derived from trans-cyclooctane-1,2-dithiol. Furthermore, according to the present invention, efficient production of a homopolymer of ethylene or a copolymer of ethylene and an α-olefin is provided with the above catalystc.

### DESCRIPTION OF EMBODIMENTS

The present invention relates to a catalyst containing a complex represented by Formula (1) for homopolymerization of ethylene or copolymerization of ethylene and an α-olefin.

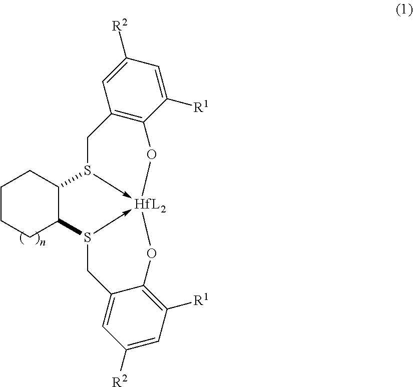

wherein n is 2 or 3; R¹ and R² are independently an optionally substituted alkyl group or a halogen atom; L is a ligand represented by CH₂R³, a halogen atom, OR⁴, or NR⁵R⁶; R³ is a hydrogen atom, an aromatic group, or a trialkylsilyl group; R⁴ is a lower alkyl group having 1 to 6 carbon atoms; and R⁵ and R⁶ are independently a hydrogen atom or a lower alkyl group having 1 to 6 carbon atoms.

The hafnium complex used in a catalyst of the present invention is represented by Formula (1), wherein n is 2 or 3, and preferably 3.

R¹ and R² are independently an optionally substituted alkyl group or a halogen atom (a fluorine atom, a chlorine atom, a bromine atom or an iodine atom), and the alkyl group is preferably an alkyl group having 1 to 30 carbon atoms, and more preferably an alkyl group having 1 to 12 carbon atoms. Examples of the alkyl group having 1 to 12 carbon atoms include a methyl group, an ethyl group, an isopropyl group, a t-butyl group, an n-pentyl group, an n-hexyl group, a cyclohexyl group, and a 1-adamantyl group. Examples of the substituent attached to the alkyl group include a lower alkyl group having 1 to 6 carbon atoms, an optionally substituted phenyl group, and a halogen atom (a fluorine atom, a chlorine atom, a bromine atom or an iodine atom). Examples of the substituent that may be attached to the phenyl group include a lower alkyl group having 1 to 6 carbon atoms or a halogen atom (a fluorine atom, a chlorine atom, a bromine atom or an iodine atom).

The two R¹s may be the same or different, and the two R²s may be the same or different.

R¹ and R² are each preferably an alkyl group, more preferably an alkyl group having 1 to 30 carbon atoms, still more preferably an alkyl group having 1 to 12 carbon atoms, and most preferably a t-butyl group, cyclohexyl group, or 1-adamantyl group.

L is CH₂R³ (a methyl group optionally having a substituent R³), a halogen atom (a fluorine atom, a chlorine atom, a bromine atom or an iodine atom), OR⁴ (an alkoxy group), or a ligand represented by NR⁵R⁶ (an amino group optionally having substituents R⁵ and R⁶). R³ is a hydrogen atom, an aromatic group, or a trialkylsilyl group. Examples of the aromatic group of R³ include a phenyl group, a 4-methoxyphenyl group, a 4-fluorophenyl group, a 4-chlorophenyl group, and a 4-bromophenyl group. The alkyl of the trialkylsilyl group can be a lower alkyl group having 1 to 6 carbon atoms and examples of the trialkylsilyl group include trimethylsilyl group, triethylsilyl group, and triisopropylsilyl group.

R⁴ is a lower alkyl group having 1 to 6 carbon atoms. Examples of the lower alkyl group include a methyl group, an ethyl group, an isopropyl group, a t-butyl group, an n-pentyl group, an n-hexyl group, and a cyclohexyl group.

R⁵ and R⁶ are independently a hydrogen atom or a lower alkyl group having 1 to 6 carbon atoms. Examples of the lower alkyl group include a methyl group, an ethyl group, an isopropyl group, a t-butyl group, an n-pentyl group, an n-hexyl group, and a cyclohexyl group.

L is preferably CH₂R³, a halogen atom or OR⁴, more preferably CH₂R³ or a halogen atom, still more preferably a methyl group, a benzyl group, a trimethylsilylmethyl group, a chlorine atom or a bromine atom, and most preferably a methyl group, a benzyl group or a chlorine atom.

Examples of the complex represented by Formula (1) include the following compounds:

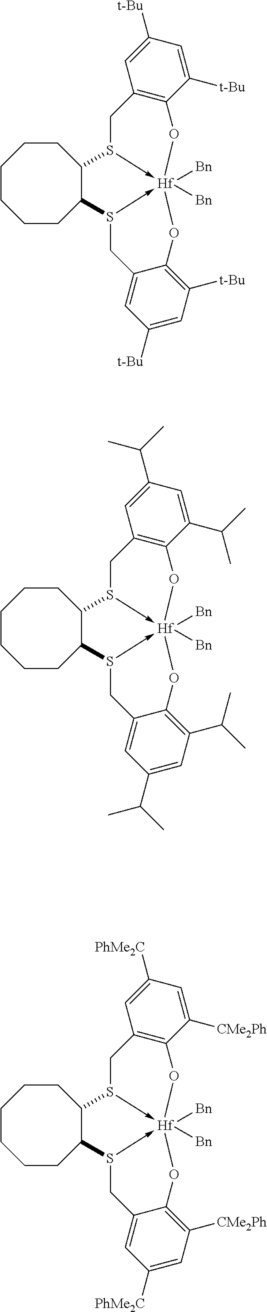

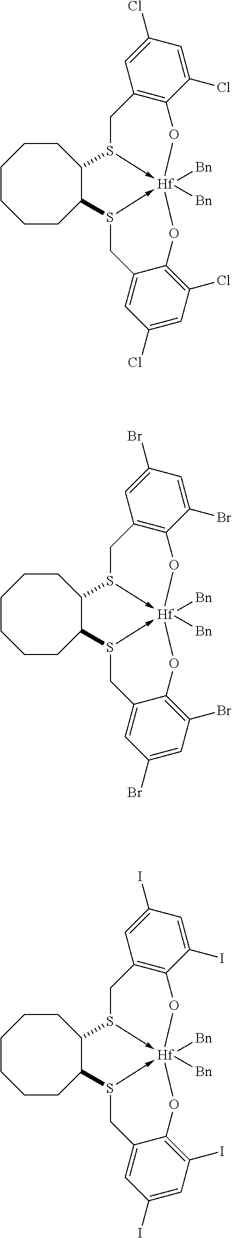

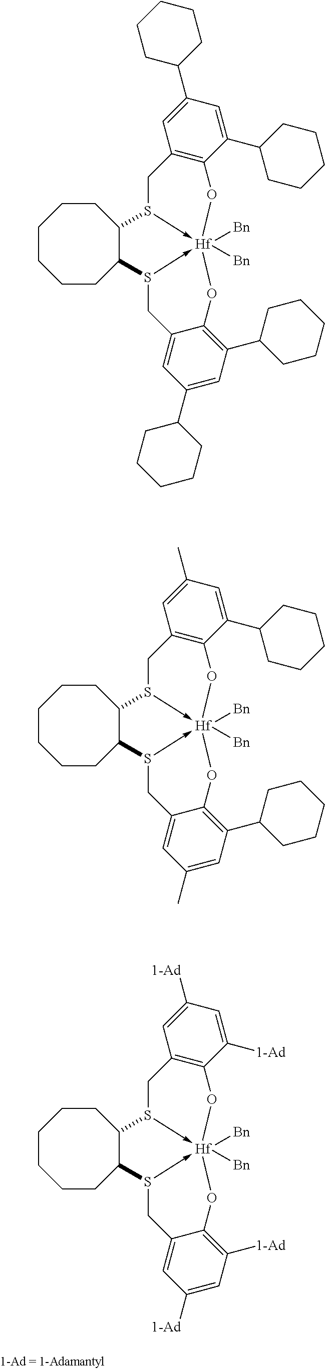

The complex also includes compounds of which the benzyl group directly bonded to the hafnium atom is replaced with a fluorine atom, a chlorine atom, a bromine atom, an iodine atom, a dimethylamino group, diethylamino group, a methoxy group, an ethoxy group or t-butoxy group, or of which the 8-membered ring is replaced with a 7-membered ring.

The complexes represented by Formula (1) can be manufactured by the following steps using starting materials represented by Formulae (2) and (3).

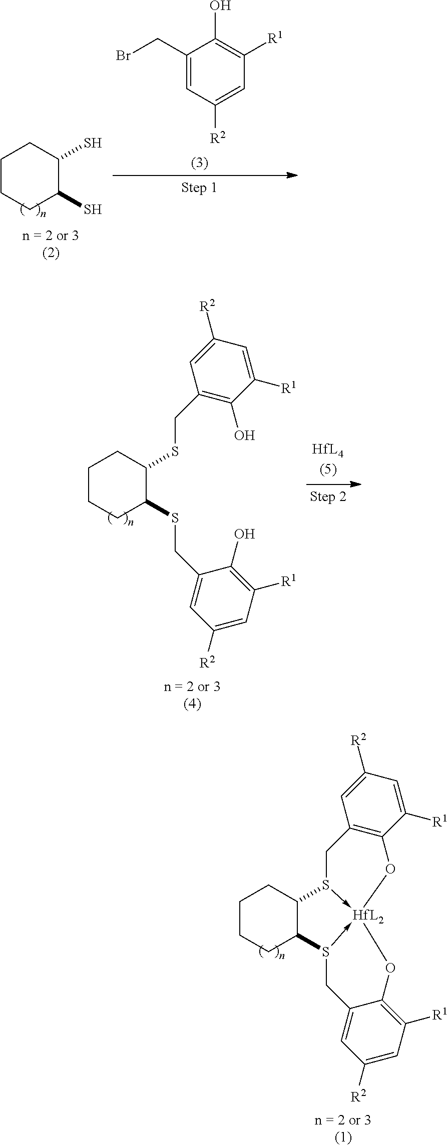

Each step will now be described in detail.

### [Step 1]

The tetradentate ligands represented by Compound (4) can be synthesized, for example, by the methods described in Non-Patent Literatures 7 and 8. In Compounds (3) and (4), n, R¹ and R² are as defined in Formula (1).

Trans-Cycloheptane-1,2-dithiol or trans-cyclooctane-1,2-dithiol corresponding to Compound (2) can be reacted with, for example, 2.0 to 4.0 equivalents, preferably 2.0 to 2.5 equivalents of 3,5-disubstituted 2-hydroxybenzyl bromide corresponding to Compound (3), thereby to yield the corresponding compound represented by Formula (4).

Examples of 3,5-disubstituted 2-hydroxybenzyl bromide include the following compounds. These compounds are known ones.

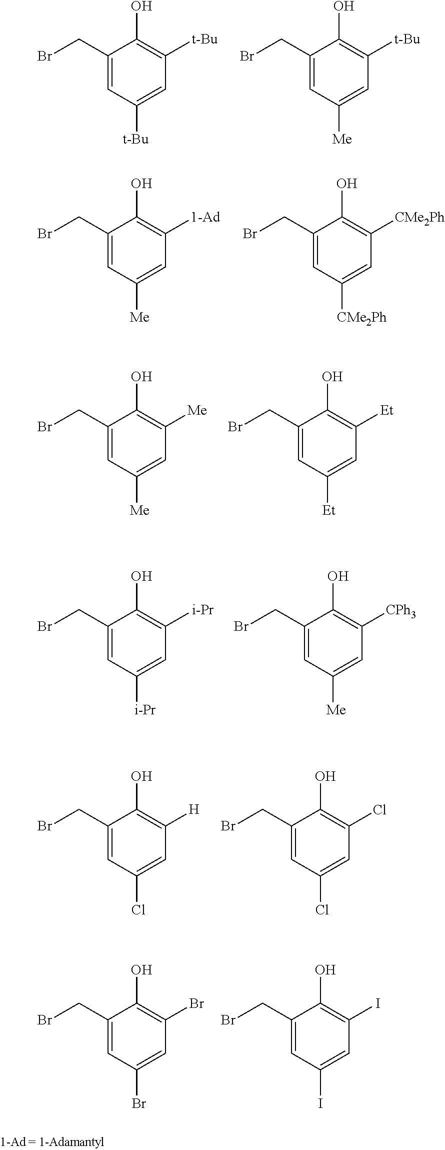

The reaction can be carried out in a stream of air, helium, argon or nitrogen, preferably in a stream of helium, argon or nitrogen, and more preferably in a stream of nitrogen or argon.

The reaction is generally carried out under atmospheric pressure since the effect of pressure can be neglected.

The temperature of reaction between the compound represented by Formula (2) with the compound represented by Formula (3) is, for example, in the range of −100° C. to 100° C., and preferably −80° C. to 80° C. However, there is no intention to limit the temperature to the ranges.

The time of reaction between the compound represented by Formula (2) and the compound represented by Formula (3) is, for example, in the range of 1 minute to 24 hours, preferably 5 minutes to 20 hours, and more preferably 30 minutes to 18 hours. However, there is no intention to limit the time to the ranges.

Examples of the compound represented by Formula (4) include the following compounds:

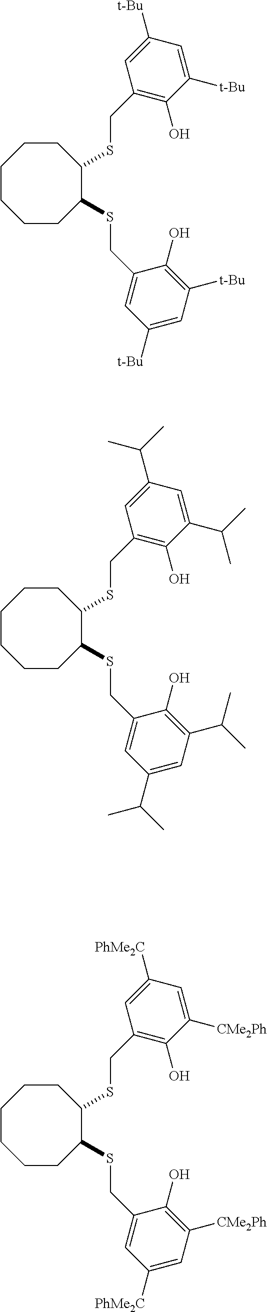

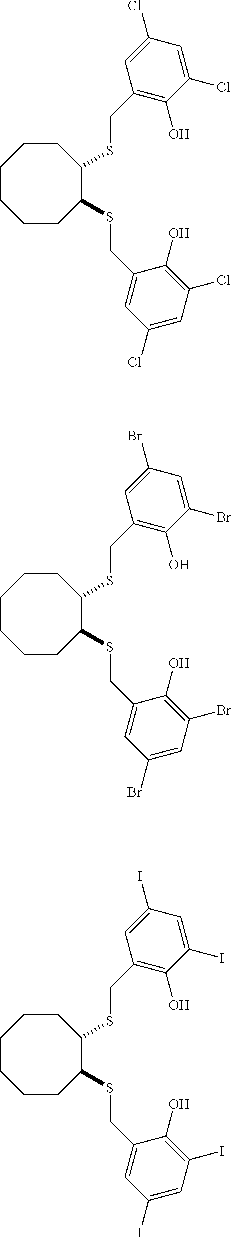 [SMILES: Oc1c(Cl)cc(Cl)cc1CS[C@H]1CCCCCC[C@@H]1SCc1cc(Cl)cc(Cl)c1O ; Oc1c(Br)cc(Br)cc1CS[C@H]1CCCCCC[C@@H]1SCc1cc(Br)cc(Br)c1O ; Oc1c(I)cc(I)cc1CS[C@H]1CCCCCC[C@@H]1SCc1cc(I)cc(I)c1O]

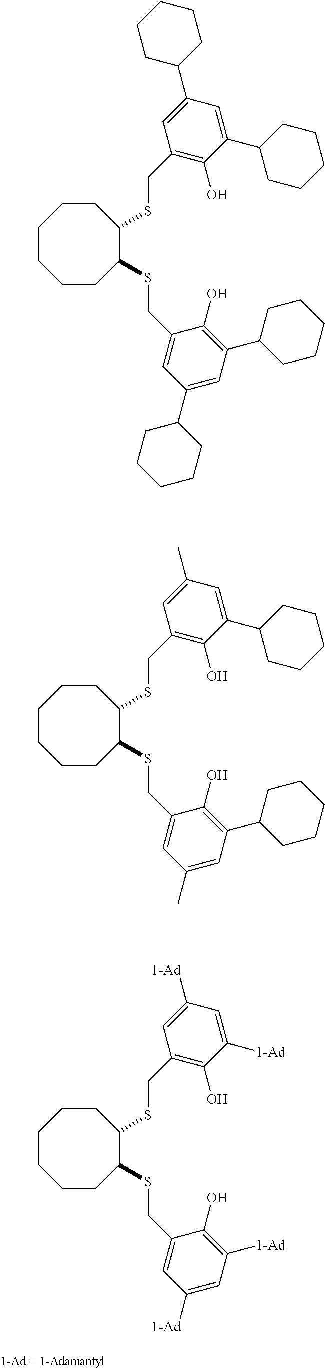

The compounds of which each 8-membered ring is replaced with a 7-membered ring are also included.

### [Step 2]

As described above, L in Compound (5) is a ligand represented by CH₂R³ (a methyl group optionally having a substituent R³), a halogen atom (a chlorine atom, a bromine atom, or an iodine atom), OR⁴ (an alkoxy group) or NR⁵R⁶ (an amino group optionally having substituents R⁵ and R⁶).

Examples of HfL₄ include Hf(CH₂Ph)₄, Hf(CH₂SiMe₃)₄, HfF₄, HfCl₄, HfBr₄, Hfl₄, Hf(OMe)₄, Hf(OEt)₄, Hf(O-i-Pr)₄, Hf(O-n-Bu)₄, Hf(O-i-Bu)₄, Hf(O-t-Bu)₄, Hf(NMe₂)₄ and Hf(NEt₂)₄, and preferably Hf(CH₂Ph)₄, Hf(CH₂SiMe₃)₄, HfCl₄, HfBr₄, Hf(OMe)₄, Hf(OEt)₄, Hf(O-i-Pr)₄, Hf(O-i-Bu)₄, Hf(O-t-Bu)₄, Hf(NMe₂)₄, and Hf(NEt₂)₄.

In the case where the compound represented by Formula (5) is Hf(CH₂R³)₄, Hf(OR)₄ or Hf(NR⁵R⁶)₄, the compound can be reacted as it is with a compound represented by Formula (4) in a solvent.

It is appropriate to carry out the reaction preferably in a stream of helium, argon, or nitrogen, more preferably nitrogen or argon since hafnium complexes are unstable to air and humidity.

The reaction is generally carried out under atmospheric pressure since the effect of pressure can be neglected.

In the present invention, the reaction temperature of the compound represented by Formula (4) with the compound represented by Formula (5) is, but not limited to, for example, in the range of −100° C. to 100° C., and preferably −80° C. to 50° C.

In the present invention, the reaction time of the compound represented by Formula (5) with a base is, but not limited to, for example, in the range of 1 minute to 24 hours, preferably 5 minutes to 12 hours, and more preferably 30 minutes to 3 hours.

In the case where the compound represented by Formula (5) is HfF₄, HfCl₄, HfBr₄ or HfI₄, the complex can be synthesized by the addition of any one of HfF₄, HfCl₄, HfBr₄, and HfI₄ to the reaction product of the compound represented by Formula (4) with a base such as an organolithium reagent, Grignard reagent or metal hydride, for example, n-butyl lithium, sec-butyl lithium, t-butyl lithium, lithium hydride, sodium hydride or potassium hydride.

In the present invention, the temperature of reaction between the reaction product of the compound represented by Formula (4) and a base with the compound represented by Formula (5) is, for example, in the range of −100° C. to 150° C., and preferably −80° C. to 50° C. However, there is no intention to limit the temperature to the ranges.

In the present invention, the reaction time of the reaction product of the compound represented by Formula (4) and a base with the compound represented by Formula (5) is, for example, in the range of 1 minute to 24 hours, preferably 5 minutes to 12 hours, and more preferably 30 minutes to 3 hours. However, there is no intention to limit the time to the ranges.

The above-prepared complex represented by Formula (1) is reacted with an organolithium reagent or Grignard reagent to synthesize a complex in which L in Formula (1) is CH₂R³.

Any solvent commonly used in similar reactions can also be used without restriction in the present invention. Examples of such solvents include hydrocarbon solvents and ether solvents; preferably toluene, benzene, o-xylene, m-xylene, p-xylene, hexane, pentane, heptane, cyclohexane, diethyl ether, and tetrahydrofuran; and more preferably diethyl ether, toluene, tetrahydrofuran, hexane, pentane, heptane, and cyclohexane.

The complex represented by Formula (1) of the present invention is used as a polymerization catalytic component for manufacturing a polymer by homopolymerization of a polymerizable monomer or copolymerization of two or more polymerizable monomers, preferably by homopolymerization.

A polymerization catalyst that is prepared by putting the complex represented by General formula (1) of the present invention into contact with the co-catalytic component (A) is used as the polymerization catalyst. The co-catalytic component may be of any type which can activate the complex represented by General formula (1) of the present invention to induce the polymerization, and may contain at least one compound selected from the group consisting of an organoaluminum compound (A-1) and a boron compound (A-2).

### Organoaluminum Compound (A-1)

Known organoaluminum compounds can be used as the compound (A-1) of the present invention. Preferred examples of the compound include organoaluminum compounds (A-1-1) represented by General formula E¹ₐAlY¹₃₋ₐ, cyclic aluminoxanes (A-1-2) having a structure represented by General formula {—Al(E²)-O—}_{b}, and linear aluminoxanes (A-1-3) having a structure represented by General formula E³{-Al(E³)-O—}_{c}AlE³₂ (wherein E¹, E² and E³ are each a hydrocarbyl group having 1 to 8 carbon atoms, and all E¹s, E²s and E³s may be the same or different; Y¹ represents a hydrogen atom or a halogen atom, and all Y¹s may be the same or different; and a is an integer of 0<a≦3, b is an integer of 2 or more, and c is an integer of 1 or more); these may be used alone or as a mixture of two or three.

Examples of the organoaluminum compound (A-1-1) represented by General formula E¹ₐAlY¹₃₋ₐ include trialkylaluminums, such as trimethylaluminum, triethylaluminum, tripropylaluminum, triisobutylaluminum, and trihexylaluminum; dialkylaluminum chlorides, such as dimethylaluminum chloride, diethylaluminum chloride, dipropylaluminum chloride, diisobutylaluminum chloride, and dihexylaluminum chloride; alkylaluminum dichlorides, such as methylaluminum dichloride, ethylaluminum dichloride, propylaluminum dichloride, isobutylaluminum dichloride, and hexylaluminum dichloride; and dialkylaluminum hydrides, such as dimethylaluminum hydride, diethylaluminum hydride, dipropylaluminum hydride, diisobutylaluminum hydride, and dihexylaluminum hydride. Preferred are trialkylaluminums; and more preferred are triethylaluminum and triisobutylaluminum.

Examples of E² and E³ in cyclic aluminoxanes (A-1-2) having a structure represented by General formula {—Al(E²)-O—}_{b}, and linear aluminoxanes (A-1-3) having a structure represented by General formula E³{-Al(E³)-O—}_{c}AlE³₂ include an alkyl group such as a methyl group, an ethyl group, an n-propyl group, an isopropyl group, an n-butyl group, an isobutyl group, an n-pentyl group, and a neopentyl group; and b is an integer of 2 or more, and c is an integer of 1 or more. Preferably, E² and E³ are each a methyl group or an isobutyl group, b is 2 to 40, and c is 1 to 40.

The above-mentioned aluminoxane is prepared by various processes without any particular restriction and may be prepared by any known process. Examples of the process of manufacturing the aluminoxane include putting a solution of a trialkylaluminum (e.g., trimethylaluminum) in an appropriate organic solvent (e.g., benzene, toluene, or aliphatic hydrocarbon) into contact with water; and putting a trialkylaluminum (e.g., trimethylaluminum) into contact with a metal salt containing water of crystallization (e.g., copper sulfate hydrate).

The resulting cyclic aluminoxane (A-1-2) having a structure represented by General formula {—Al(E²)-O—}_{b}, and linear aluminoxane (A-1-3) having a structure represented by General formula E³{-Al(E³)-O—}_{c}AlE³₂ may be, as necessary, dried through the removal of volatile components before use. Furthermore, the resulting dried compound after the removal of volatile components may be washed with an appropriate organic solvent (such as benzene, toluene, or aliphatic hydrocarbon) and dried again before use.

### Boron Compound (A-2)

In the present invention, any one of a boron compound (A-2-1) represented by General formula BR¹¹R¹²R¹³, a boron compound (A-2-2) represented by General formula W⁺(BR¹¹R¹²R¹³R¹⁴)⁻, and a boron compound (A-2-3) represented by General formula (V-H)⁺(BR¹¹R¹²R¹³R¹⁴)⁻ can be used as the compound (A-2).

In the boron compound (A-2-1) represented by General formula BR¹¹R¹²R¹³, B is a boron atom having a valence of three; and R¹¹ to R¹³ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹³ are each a halogen atom, a hydrocarbyl group having 1 to 20 carbon atoms, or a halogenated hydrocarbyl group having 1 to 20 carbon atoms.

Examples of the compound (A-2-1) include triphenylborane, tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, and bis(pentafluorophenyl)phenylborane, and the most preferred are triphenylborane and tris(pentafluorophenyl)borane.

In the boron compound (A-2-2) represented by General formula W⁺(BR¹¹R¹²R¹³R¹⁴)⁻, W⁺ is an inorganic or organic cation; B is a boron atom having a valence of three; and R¹¹ to R¹⁴ are the same as R¹¹ to R¹³ of the compound (A-2-1). More specifically, R¹¹ to R¹⁴ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹⁴ are each a halogen atom, a hydrocarbyl group having 1 to 20 carbon atoms, and a halogenated hydrocarbyl group having 1 to 20 carbon atoms.

Examples of the inorganic cation W⁺ include ferrocenium cations, alkyl-substituted ferrocenium cations, and a silver cation, and examples of the organic cation W⁺ include triphenylcarbenium cations. Examples of (BR¹¹R¹²R¹³R¹⁴)⁻ include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,3,4-trifluorophenyl)borate, bis(pentafluorophenyl)phenylborate, and tetrakis[3,5-bis(trifluoromethyl)phenyl]borate.

Examples of the compound represented by General formula W⁺(BR¹¹R¹²R¹³R¹⁴)⁻ include ferrocenium tetrakis(pentafluorophenyl)borate, 1,1′-dimethylferrocenium tetrakis(pentafluorophenyl)borate, silver tetrakis(pentafluorophenyl)borate, triphenylcarbenium tetrakis(pentafluorophenyl)borate, and triphenylcarbenium tetrakis[3,5-bis(trifluoromethyl)phenyl]borate. The most preferred is triphenylcarbenium tetrakis(pentafluorophenyl)borate.

In the boron compound (A-2-3) represented by General formula (V-H)⁺(BR¹¹R¹²R¹³R¹⁴)⁻, V is a neutral Lewis base; (V-H)⁺ is a Broensted acid; B is a boron atom having a valence of three; and R¹¹ to R¹⁴ are the same as R¹¹ to R¹³ in the compound (A-2-3). More specifically, R¹¹ to R¹⁴ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹⁴ are each a halogen atom, a hydrocarbyl group having 1 to 20 carbon atoms, and a halogenated hydrocarbyl group having 1 to 20 carbon atoms.

Examples of (V-H)⁺, which is a Broensted acid, include trialkyl-substituted ammoniums, N,N-dialkylaniliniums, dialkylammoniums, triarylphosphoniums, and examples of (BR¹¹R¹²R¹³R¹⁴)⁻ include the same as described above.

Examples of the compound represented by General formula (V-H)⁺(BR¹¹R¹²R¹³R¹⁴)⁻ include triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis[3,5-bis(trifluoromethyl)phenyl]borate, N,N-dimethyl anilinium tetrakis(pentafluorophenyl)borate, N,N-diethyl anilinium tetrakis(pentafluorophenyl)borate, N,N-2,4,6-pentamethylanilinium tetrakis(pentafluorophenyl)borate, N,N-dimethylanilinium tetrakis [3,5-bis(trifluoromethyl)phenyl]borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, tri(dimethylphenyl)phosphonium tetrakis(pentafluorophenyl)borate, and triphenylcarbenium tetrakis(pentafluorophenyl)borate. The most preferred is triphenylcarbenium tetrakis(pentafluorophenyl)borate, tri(n-butyl)ammonium tetrakis(pentafluorophenyl)borate or N,N-dimethylanilinium tetrakis(pentafluorophenyl)borate.

The contact between the complex represented by (1) and a co-catalyst component to manufacture a catalyst for olefin polymerization of the present invention may be made by any means which can put the complex represented by (1) into contact with the co-catalyst component to form the catalyst. Examples of such means include preliminarily mixing the component represented by (1) and the co-catalyst component, optionally diluted with a solvent, to be in contact with each other, or adding the complex represented by (1) and the co-catalyst component separately to a polymerization tank to put them into contact with each other in the tank. In this method, mixed co-catalyst components of different types, parts of which may be either preliminarily mixed or separately added in the polymerization tank, can be used.

Each component is desirably used in such an amount that the molar ratio of the compound (A-1) to the complex represented by General formula (1) is generally in the range of 0.01 to 10000, preferably 1 to 5000, and the molar ratio of the compound (A-2) to the complex represented by General formula (1) is in the range of 0.01 to 100, and preferably 1.0 to 50.

In the case of manufacturing the catalyst in a polymerization reactor before polymerization reaction, although the concentration of each component supplied in a solution, suspension, or slurry in a solvent may be suitably selected according to the conditions such as the performance of a supply device. Desirably, the complex represented by General formula (1) is generally used in a concentration range of usually 0.0001 to 10000 mmol/L, preferably 0.001 to 1000 mmol/L, and more preferably 0.01 to 100 mmol, the compound (A-1) is generally used in a concentration range, on the basis of Al atoms, of usually 0.01 to 10000 mmol/L, preferably 0.05 to 5000 mmol/L, and more preferably 0.1 to 2000 mmol/L, and the compound (A-2) is generally used in a concentration range of usually 0.001 to 500 mmol/L, preferably 0.01 to 250 mmol/L, and more preferably 0.05 to 100 mmol/L.

The catalyst for olefin polymerization is prepared by putting the complex represented by General formula (1) into contact with the compound (A-1) and/or the compound (A-2). In the case where the catalyst for olefin polymerization prepared by putting the complex represented by General formula (1) into contact with the compound (A-1) is used, the compound (A-1) is preferably a cyclic aluminoxane (A-1-2) and/or a linear aluminoxane (A-1-3). In other preferred embodiments, the catalysts for olefin polymerization include catalysts for olefin polymerization prepared by putting the complex represented by General formula (1) into contact with the compound (A-1) and the compound (A-2), where a preferred compound (A-1) is the compound (A-1-1) for its ease of use, and preferred compound (A-2) is the compound (A-2-1) or (A-2-2).

### Method for Manufacturing Ethylenic Polymer

The method for manufacturing an ethylenic polymer of the present invention comprises homopolymerization of ethylene or copolymerization of ethylene and an α-olefin in the presence of a catalyst of the present invention. Polymerization of ethylene alone yields polyethylene as an ethylenic polymer. Copolymerization of ethylene and an α-olefin yields a copolymer of ethylene and an α-olefin. The content of an α-olefin in the copolymer of ethylene and an α-olefin is less than 50 mol %, preferably 35 mol % or less, more preferably 15 mol % or less, and still more preferably 10 mol % or less. A single or multiple α-olefin(s) may be used. Polymerization of ethylene and a single α-olefin yields a copolymer of ethylene and a single α-olefin, and polymerization of ethylene and multiple α-olefins yields a copolymer of ethylene and multiple α-olefins. Any types of α-olefin compounds, for example, monoolefins or diolefins, can be used for polymerization without restrictions. Examples of the monoolefins include 1-alkenes (including branched alkenes), such as propylene, 1-butene, 1-pentene, 1-hexene, 1-heptene, 1-octene, 1-nonene, 1-decene, and 4-methyl-1-pentene. Examples of the diolefins include butadiene and 1,5-hexadiene. Examples of the monomers constituting the copolymers include ethylene and propylene; ethylene and 1-butene; ethylene and 1-pentene; ethylene and 1-hexene; ethylene and 1-octene; ethylene and 1-decene; ethylene and 4-methyl-1-pentene, ethylene and butadiene; and ethylene and 1,5-hexadiene, preferably ethylene and propylene; ethylene and 1-butene; ethylene and 1-pentene; ethylene and 1-hexene; ethylene and 1-octene; and ethylene and 4-methyl-1-pentene, more preferably ethylene and propylene; ethylene and 1-butene; ethylene and 1-hexene; and ethylene and 1-octene, and still more preferably ethylene and propylene; ethylene and 1-butene; and ethylene and 1-hexene.

Non-limiting examples of polymerization include solvent polymerization and slurry polymerization, which use as solvents aliphatic hydrocarbon such as butane, pentane, hexane, heptane or octane, aromatic hydrocarbon such as benzene or toluene, or halogenated hydrocarbon such as methylene dichloride. The polymerization can be either continuous polymerization or batch polymerization. The polymerization temperature and time can be determined in consideration of a desired weight-average molecular weight and the activity and employing amount of the catalyst. The polymerization temperature can be generally in the range of −50° C. to 200° C., and preferably in the range of −20° C. to 100° C. The polymerization pressure is preferably in the range of the normal pressure to 50 MPa. The polymerization time, which can be appropriately determined according to the type of the polymer to be prepared and the reactor, is generally in the range of 1 minute to 20 hours, and preferably 5 minutes to 18 hours. However, there is no intention to limit the temperature to the ranges. Furthermore, in the present invention, a chain transfer agent such as hydrogen can be added to adjust the molecular weight of the copolymer.

When a solvent is used in polymerization reaction, the concentration of each compound in the solvent is not specifically limited. The concentration of the hafnium complex in a solvent can be, for example, in the range of 1×10⁻⁸ mmol/L to 10 mol/L, and the concentration of the co-catalyst, for example, 1×10⁻⁸ mmol/L to 10 mol/L. The volume ratio of olefin to solvent (olefin:solvent) is in the range of 100:0 to 1:1000. These ranges are exemplary, and not restrictive. In the case whrere no solvent is used, the appropriate concentration can be determined with reference to the above range.

The unreacted monomer remaining with solvent in the resultant polymer can be removed as follows: For viscous polymers, the monomer can be removed with a vacuum pump. This process, however, cannot remove the catalyst. For solid polymers, the monomer can be removed by washing with a solvent such as methanol after the removal of the residual solvent. This method can remove a certain level of catalyst.

### EXAMPLES

The present invention will now be explained in more detail by way of examples and comparative examples, but the present invention should not be limited thereto. Each item in Examples and Comparative Examples was measured by the following procedures.

### (1) Melting Point

The melting point was determined with a thermal analyzer: a differential scanning calorimeter (Diamond DSC, manufactured by Perkin Elmer Inc.) through the following procedure:
1) Being held about 10 mg of a sample at 150° C. for 5 minutes in nitrogen atmosphere,
2) Being cooled from 150° C. to 20° C. (at 5° C./min), and retained at 20° C. for 1 minute.
3) Being heated from 20° C. to 150° C. (at 5° C./min).

### (2) Molecular Weight and Molecular Weight Distribution

These values were measured by gel permeation chromatography (GPC) under the following conditions. A calibration curve was determined using standard polystyrene samples. The molecular weight distribution was evaluated with the ratio (Mw/Mn) of the weight-average molecular weight (Mw) to the number-average molecular weight (Mn).
Apparatus: type 150C, manufactured by Millipore Waters Co.
Columns: TSK-GEL GMH-HT 7.5×600 two columns
Measuring temperature: 152° C.
Solvent: ortho-dichlorobenzene
Concentration: 5 mg/5 mL
   (3) Intrinsic Viscosity ([η]) (unit: dl/g)

The intrinsic viscosity was measured with an Ubbellohde viscometer using tetralin as a solvent at a measuring temperature of 135° C.

### (4) 1-Hexene Unit Content in Copolymer (SCB, Unit: 1/1000C)

Carbon nuclear magnetic resonance spectra (¹³C-NMR) were obtained by carbon nuclear magnetic resonance spectroscopy under the following conditions to determine the 1-Hexene unit content in copolymer (1/1000C).

### <Condition for Measurement>

Apparatus: AVANCE600, manufactured by Bruker Corp.
Solvent used for measurement: a mixture of 1,2-dichrolobenzene/1,2-dichrolobenzene-d₄=75/25 (volume ratio)
Measuring temperature: 130° C.
Measuring mode: proton decoupling mode
Pulse width: 45°
Pulse repetition time: 4 seconds
Chemical shift reference: tetramethylsilane

### <Calculation Procedure>

1-hexene concentration (1/1000C) for 1000 carbon atoms was determined from the peak intensity observed at 23.0 to 23.5 ppm relative to the sum total 1000 of integral intensities of all peaks observed at 5 to 50 ppm.

(5) 1-Hexene Unit Content in Copolymer (SCB, unit: mol %)

The hexene concentration was determined from the following equation using the following integral values in ¹³C-NMR spectrum:
A: integral value from 40.5 to 41.5 ppm
B: integral value from 39.5 to 40.5 ppm
C: integral value from 37.0 to 39.5 ppm
D: integral value from 35.8 ppm
D+E: integral value from 33.2 to 36.8 ppm
F+G: integral value from 25.5 to 33.2 ppm
G: integral value from 26.5 to 28.5 ppm
H: integral value from 24.1 to 24.9 ppm
H1=(1.5×A+2×B+(D+E)−D)/3
H2=(A+2×C+2×D)/2
H′=(H1+H2)/2
E′={(F+G)−3×A−3×B−G−H}/2+H′
Hexene mol %=100×H′/(H′+E′)

### Reference Example 1

### Synthesis of trans-1,2-bis(2-hydroxy-3,5-di-tert-butylbenzylsulfanyl)cyclooctane

In an argon atmosphere, trans-cyclooctane-1,2-dithiol (2.18 g, 12.4 mmol) and 3,5-di-t-butyl-2-hydroxybenzyl bromide (7.52 g, 25.1 mmol) were dissolved in tetrahydrofuran (80 mL), and the solution was cooled to 0° C. Triethylamine (3.5 mL, 24.9 mmol) was then added thereto, and the solution was stirred at 0° C. for 1 hour and further at room temperature overnight. The formed precipitate was removed by filtration and the filtrate was concentrated under reduced pressure. Ether and a saturated aqueous ammonium chloride solution were added to the residue. The ether layer was then washed with water and was dried through anhydrous magnesium sulfate, and the solvent was evaporated under reduced pressure. The residue was purified by silica gel column chromatography (developing solvent: hexane/dichloromethane=1/1) to give a title compound as a colorless crystal (6.74 g, yield 89%).

Melting point: 122 to 123° C. (recrystallized from hexane)

¹H-NMR (400 MHz, δ, ppm, CDCl₃)

1.12-1.94 (m, 48H), 2.63-2.65 (m, 2H), 3.81 (d, J=13 Hz, 2H), 3.90 (d, J=13 Hz, 2H), 6.92 (d, J=2 Hz, 2H), 6.95 (s, 2H), 7.26 (d, J=2 Hz, 2H).

¹³C-NMR (100.7 MHz, δ, CDCl₃)

25.7, 25.8, 29.8, 31.2, 31.6, 34.2, 35.0, 35.4, 49.6, 121.6, 123.7, 125.4, 137.4, 142.0, 152.2.

Elemental analysis: calculated value (C₃₈H₆₀O₂S₂), C, 74.45%; H, 9.87%

Observed value: C, 74.39%; H, 10.09%

Reference: A. Ishii, A. Ono, N. Nakata, J. SuIf Chem 2009, 30, 236-244.

### Reference Example 2

### Synthesis of trans-1,2-bis(2-hydroxy-3,5-di-tert-butylbenzylsulfanyl)cyclohexane

In an argon atmosphere, trans-cyclohexane-1,2-dithiol (1.08 g, 7.3 mmol) and 3,5-di-t-butyl-2-hydroxybenzyl bromide (4.58 g, 15.3 mmol) were dissolved in tetrahydrofuran (90 mL), and the solution was cooled to 0° C. Triethylamine (2.13 mL, 15.3 mmol) was then added thereto and the solution was stirred at 0° C. for 15 hours. The formed precipitate was removed by filtration and the filtrate was concentrated under reduced pressure. Ether and dilute hydrochloric acid were added to the residue. The ether layer was then washed with water and was dried through anhydrous magnesium sulfate, and the solvent was evaporated under reduced pressure. The residue was purified by silica gel column chromatography (developing solvent: hexane/dichloromethane=1/1) to give a title compound as a colorless crystal (3.86 g, yield 90%).

Melting point: 104 to 106° C., decomposed (recrystallized from ethanol)

¹H-NMR (400 MHz, δ, ppm, CDCl₃)

1.19-1.43 (m, 44H), 2.09-2.15 (m, 2H), 2.58-2.61 (m, 2H), 3.79 (s, 4H), 6.75 (s, 2H), 6.93 (d, J=2 Hz, 2H), 7.25 (d, J=2 Hz, 2H).

¹³C-NMR (100.7 MHz, δ, CDCl₃)

24.7, 29.7, 31.6, 32.6, 33.9, 34.2, 35.0, 48.1, 121.6, 123.7, 125.2, 137.3, 142.2, 152.0.

Elemental analysis: calculated value (C₃₆H₅₆O₂S₂): C, 73.92%; H, 9.34%.

Observed value: C, 74.17%; H, 9.31%

### Reference Example 3

### [Cyclooctanediyl-trans-1,2-bis(2-oxoyl-3,5-di-tert-butylbenzylsulfanyl)]dibenzylzirconium

The following experiment was carried out in an argon atmosphere in a glove box. In a 50 mL Schlenk flask, trans-1,2-bis(2-hydroxy-3,5-di-tert-butylbenzylsulfanyl)cyclooctane (207 mg, 0.336 mmol) was dissolved in toluene (10 mL), and then tetrabenzylzirconium (153 mg, 0.336 mmol) in toluene (10 mL) was added dropwise to the solution at room temperature. The mixture was stirred for one hour. Toluene was evaporated under reduced pressure, and the residue was washed with hexane (2 mL) and was dried to give a title compound as a colorless crystal (216 mg, yield 76%).

Melting point: 181-183° C. (decomposed)

¹H-NMR (400 MHz, δ, ppm, C₆D₆)

1.16-1.80 (m, 48H), 2.16 (d, J=10 Hz, 2H), 2.42 (m, 2H), 2.78 (d, J=10 Hz, 2H), 3.16 (d, J=14 Hz, 2H), 3.50 (d, J=14 Hz, 2H), 6.61 (d, J=2 Hz, 2H), 6.90 (t, J=8 Hz, 2H), 7.09 (t, J=8 Hz, 4H), 7.25 (t, J=8 Hz, 4H), 7.52 (d, J=2 Hz, 2H).

¹³C-NMR (100.4 MHz, δ, ppm, C₆D₆)

25.2, 26.1, 28.6, 30.6, 31.7, 34.2, 34.8, 35.7, 48.7, 64.0, 122.0, 123.1, 124.3, 126.2, 128.5, 128.7, 129.6, 140.9, 145.8, 158.0.

Elemental analysis: calculated value (C₅₂H₇₂O₂S₂Zr), C, 70.61%; H, 8.21%.

Observed value: C, 70.54%; H, 8.31%.

### Reference Example 4

### [Cyclohexanediyl-trans-1,2-bis(2-oxoyl-3,5-di-tert-butylbenzylsulfanyl)]dibenzylhafnium

The following experiment was carried out in an argon atmosphere in a glove box. In a 100 mL Schlenk flask, trans-1,2-bis(2-hydroxy-3,5-di-tert-butylbenzylsulfanyl)cyclohexane (200.0 mg, 0.342 mmol) was dissolved in toluene (10 mL), and then tetrabenzylhafnium (185.7 mg, 0.342 mmol) in toluene (10 mL) was added dropwise to the solution at room temperature. The mixture was stirred for one hour. Toluene was evaporated under reduced pressure, and the residue was washed with hexane (2 mL) three times and was dried to give a title compound (diastereomeric mixture) as a colorless crystal (201.3 mg, yield 62%). The diastereomer ratio was 64/36.

Major: ¹H-NMR (400 MHz, δ, ppm, CD₃C₆D₅)

1.06-1.92 (m, 44H), 2.55(d, J=12.0 Hz, 2H), 2.84(d, J=12.0Hz, 2H), 3.21(d, J=14.0 Hz, 2H), 3.37(d, J=14.0 Hz, 2H), 6.62 (d, J=2.4 Hz, 2H), 6.74-6.81(m, 2H), 7.04-7.12(m, 6H), 7.25(d, J=7.6 Hz, 4H), 7.54 (d, J=2.4 Hz, 2H).

Minor: ¹H-NMR (400 MHz, δ, ppm, CD₃C₆D₅)

1.06-1.92 (m, 44H), 2.38(d, J=11.6 Hz, 2H), 2.85(d, J=14.0 Hz, 2H), 2.94(d, J=11.6 Hz, 2H), 3.18(d, J=14.0 Hz, 2H), 6.59 (d, J=2.4 Hz, 2H), 6.74-6.81(m, 2H), 7.04-7.12(m, 6H), 7.31(d, J=7.6 Hz, 4H), 7.47 (d, J=2.4 Hz, 2H).

### Reference Example 5

### [Cyclooctanediyl-trans-1,2-bis(2-oxoyl-3,5-di-tert-butylbenzylsulfanyl)]dibenzylhafnium

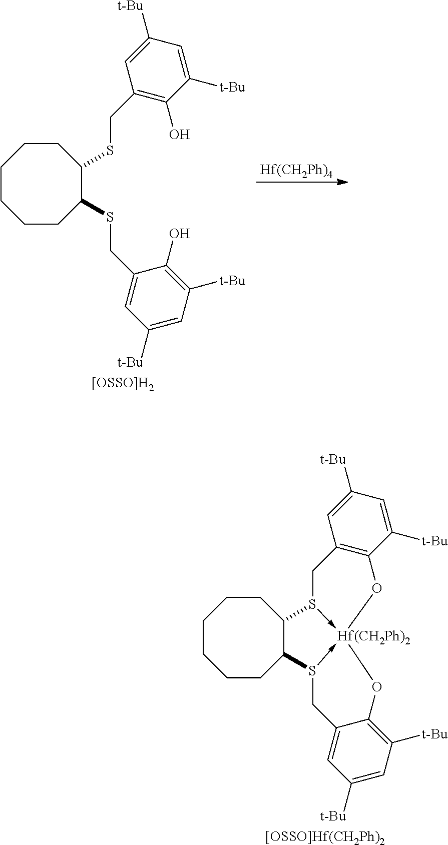

The following experiment was carried out in an argon atmosphere in a glove box. In a 50 mL Schlenk flask, trans-1,2-bis(2-hydroxy-3,5-di-tert-butylbenzylsulfanyl)cyclooctane (192 mg, 0.313 mmol) was dissolved in toluene (10 mL), and then tetrabenzylzirconium (170 mg, 0.313 mmol) in toluene (10 mL) was added dropwise to the solution at room temperature. The mixture was stirred for one hour. Toluene was evaporated under reduced pressure, and the residue was washed with hexane (2 mL) and was dried to give a title compound as a colorless crystal (209 mg, yield 69%).

Melting point: 203° C. (decomposed)

¹H-NMR (400 MHz, δ, ppm, C₆D₆)

1.18-1.94 (m, 48H), 2.35 (m, 2H), 2.61 (d, J=12 Hz, 2H), 2.88 (d, J=12 Hz, 2H), 3.13 (d, J=14 Hz, 2H), 3.41 (d, J=14 Hz, 2H), 6.62 (d, J=2 Hz, 2H), 6.78 (t, J=8 Hz, 2H), 7.10 (t, J=8 Hz, 4H), 7.29 (t, J=8 Hz, 4H), 7.57 (d, J=2 Hz, 2H).

¹³C-NMR (100.4 MHz, δ, ppm, C₆D₆)

25.1, 26.2, 28.8, 30.5, 31.8, 32.1, 34.2, 35.6, 49.1, 77.2, 121.4, 121.8, 124.6, 125.6, 126.0, 129.3, 138.5, 141.1, 148.4, 157.9.

Elemental analysis: calculated value (C₅₂H₇₂O₂S₂Hf), C, 64.27%; H, 7.47%.

Observed value: C, 63.87%; H, 7.59%.

### Reference Example 6

### [Cyclooctanediyl-trans-1,2-bis(2-oxoyl-3,5-di-tert-butylbenzylsulfanyl)]dichlorohafnium

The following experiment was carried out in an argon atmosphere. In a 100 mL Schlenk flask, trans-1,2-bis(2-hydroxy-3,5-di-tert-butylbenzylsulfanyl)cyclooctane (1.00 g, 1.63 mmol) was dissolved in diethyl ether (20 mL), and then n-butyl lithium (2 mL, 1.65 mol/L, 3.30 mmol) was added to the solution. The mixture was stirred at 0° C. for 30 minutes. The solution was then added dropwise to tetrachlorohafnium (530 mg, 1.65 mmol) in diethyl ether (50 mL) at room temperature and the mixture was stirred overnight. The formed precipitate was removed by filtration and the filtrate was concentrated under reduced pressure. The residue was washed with pentane (5 mL) and was dried to give a title compound as a colorless crystal (558 mg, yield 40%).

¹H-NMR (400 MHz, δ, ppm, C₆D₆)

0.54-1.86 (m, 48H), 2.56 (br s, 2H), 3.20 (d, J=14 Hz, 2H), 4.35 (d, J=14 Hz, 2H), 6.56 (br s, 2H), 7.56 (br s, 2H).

¹³C-NMR (100.4 MHz, δ, ppm, C₆D₆)

24.9, 26.1, 28.8, 30.4, 31.8, 34.3, 35.5, 36.0, 49.3, 120.3, 125.1, 125.7, 139.4, 142.1, 157.3.

### Reference Example 7

Method for Preparing d-MAO

PMAO-S in toluene (aluminum content: 6.1 wt %, manufactured by Tosoh Finechem Corp.) was measured out with a 100 ml syringe, and was placed into a nitrogen-purged 200 ml two-necked flask with a three-way cock and a stirrer bar. The solution was evacuated so that the volatile components were removed. The resulting white solid was dissolved in dehydrated toluene (100 mL), and then the volatile components were removed under reduced pressure. This procedure was repeated two more times to give a white powder (14.1 g).

### Example 1

A stirrer-equipped autoclave (internal volume 400 ml) was dried under vacuum, purged with argon, and charged with toluene (185 mL) as a solvent and 1-hexene (15 mL) as a co-monomer. After the reactor was heated to 40° C., ethylene was fed thereto while its partial pressure was adjusted to 0.6 MPa, and d-MAO (120 mg) and then [cyclooctanediyl-trans-1,2-bis(2-oxoyl-3,5-di-tert-butylbenzylsulfanyl)]dibenzylhafnium (1 μmol/mL, toluene solution) (0.10 mL, 0.10 μmol) were added to initiate polymerization. Polymerization was carried out for 60 minutes while the temperature was maintained at 40° C. to give ethylene/1-hexene copolymer (3.10 g), with polymerization activity=3.1×10⁷ g/mol, melting point=98.7° C., Mw=18,400, and Mw/Mn=2.2. The hexene unit content of the resulting ethylene/1-hexene copolymer was 6.22 mol %.

### Comparative Example 1

A stirrer-equipped autoclave (internal volume 400 ml) was dried under vacuum, purged with argon, and charged with toluene (185 mL) as a solvent and 1-hexene (15 mL) as a co-monomer. After the reactor was heated to 40° C., ethylene was fed thereto while its partial pressure was adjusted to 0.6 MPa, and d-MAO (120 mg) and then [cyclohexanediyl-trans-1,2-bis(2-oxoyl-3,5-di-tert-butylbenzylsulfanyl)]dibenzylhafnium (0.6 μmol/mL, toluene solution) (0.17 mL, 0.10 μmol) were added to initiate polymerization. Polymerization was carried out for 60 minutes while the temperature was maintained at 40° C. to give ethylene/1-hexene copolymer (0.15 g), with polymerization activity=1.5×10⁶ g/mol, Mw=19,500, and Mw/Mn=2.6.

### Comparative Example 2

A stirrer-equipped autoclave (internal volume 400 ml) was dried under vacuum, purged with argon, and charged with toluene (185 mL) as a solvent and 1-hexene (15 mL) as a co-monomer. After the reactor was heated to 40° C., ethylene was fed thereto while its partial pressure was adjusted to 0.6 MPa, and d-MAO (120 mg) and then [ethanediyl-trans-1,2-bis(2-oxoyl-3,5-di-tert-butylbenzylsulfanyl)]dibenzylhafnium (0.2 μmol/mL, toluene solution) (0.50 mL, 0.10 μmol) were added to initiate polymerization. Polymerization was carried out for 60 minutes while the temperature was maintained at 40° C. to give ethylene/1-hexene copolymer (0.10 g), with polymerization activity=1.0×10⁶ g/mol, Mw=2,900, and Mw/Mn=1.8.

### Example 2

Example 2 was carried out as in Example 1 except that 198 mL of toluene and 2 mL of 1-hexene were used, yielding an ethylene/1-hexene copolymer (1.80 g) with polymerization activity=1.8×10⁷ g/mol, melting point=125.7° C., Mw=22,300, and Mw/Mn=2.4. The hexene unit content of the resulting ethylene/1-hexene copolymer was 0.73 mol %.

### Example 3

Example 3 was carried out as in Example 1 except that 200 mL of toluene and 0 mL of 1-hexene were used, yielding an ethylenic polymer.

### Comparative Example 3

A stirrer-equipped autoclave (internal volume 400 ml) was dried under vacuum, purged with argon, and charged with toluene (200 mL). After the reactor was heated to 40° C., ethylene was fed thereto while its partial pressure was adjusted to 0.6 MPa, and d-MAO (120 mg) and then [cyclohexanediyl-trans-1,2-bis(2-oxoyl-3,5-di-tert-butylbenzylsulfanyl)]dibenzylhafnium (0.6 μmol/mL, toluene solution) (0.17 mL, 0.10 μmol) were added to initiate polymerization. Polymerization was carried out for 60 minutes while the temperature was maintained at 40° C. to give an ethylenic polymer (0.15 g), with polymerization activity=1.5×10⁶ g/mol, Mw=22,800, and Mw/Mn=2.7.

### Comparative Example 4

A stirrer-equipped autoclave (internal volume 400 ml) was dried under vacuum, purged with argon, and charged with toluene (200 mL). After the reactor was heated to 40° C., ethylene was fed thereto while its partial pressure was adjusted to 0.6 MPa, and d-MAO (120 mg) and then [ethanediyl-trans-1,2-bis(2-oxoyl-3,5-di-tert-butylbenzylsulfanyl)]dibenzylhafnium (0.2 μmol/mL, toluene solution) (0.50 mL, 0.10 μmol) were added to initiate polymerization. Polymerization was carried out for 60 minutes while the temperature was maintained at 40° C. to give an ethylene/1-hexene copolymer (0.10 g), with polymerization activity=1.0×10⁶ g/mol, Mw=10,100, and Mw/Mn=4.0.

Table 1 shows the results of polymerization in Examples 1 to 3 and Comparative Examples 1 to 4.

TABLE 1

| Example & | | Polymerization | Melting | | | | | |
|---|---|---|---|---|---|---|---|---|
| Comparative | Yield | Activity | Point | | | [η] | SCB | SCB |
| Example | g | g/mol | ° C. | M_{w} | M_{w}/Mₙ | dl/g | mol % | 1/1000 C. |
| Ex. 1 | 3.10 | 3.1 × 10⁷ | 98.7 | 18,400 | 2.2 | — | 6.2 | 27.5 |
| Comp. Ex. 1 | 0.15 | 1.5 × 10⁶ | — | 19,500 | 2.6 | 0.44 | — | — |
| Comp. Ex. 2 | 0.10 | 1.0 × 10⁶ | — | 2,900 | 1.8 | — | — | — |
| Ex. 2 | 1.80 | 1.8 × 10⁷ | 125.7 | 22,300 | 2.4 | — | 0.7 | 3.5 |
| Ex. 3 | 0.30 | 3.0 × 10⁶ | 131.0 | 10,800 | 2.6 | — | — | — |
| Comp. Ex. 3 | 0.15 | 1.5 × 10⁶ | — | 22,800 | 2.7 | 0.52 | — | — |
| Comp. Ex. 4 | 0.10 | 1.0 × 10⁶ | — | 10,100 | 4.0 | — | — | — |

### Example 4

A stirrer-equipped autoclave (internal volume 400 ml) was dried under vacuum, purged with argon, and charged with toluene (100 mL) as a solvent and propylene (5 g) as a co-monomer. After the reactor was heated to 40° C., ethylene was fed thereto while its partial pressure was adjusted to 0.6 MPa, and d-MAO (101.8 mg) and then [cyclooctanediyl-trans-1,2-bis(2-oxoyl-3,5-di-tert-butylbenzylsulfanyl)]dibenzylhafnium (1 μmol/mL, toluene solution) (0.02 mL, 0.02 μmol) were added to initiate polymerization. Polymerization was carried out for 60 minutes while the temperature was maintained at 40° C. to give an ethylene/propylene copolymer (0.27 g), with polymerization activity=1.4×10⁷ g/mol, Mw=13,000, and Mw/Mn=2.0.

### Example 5

A stirrer-equipped autoclave (internal volume 400 ml) was dried under vacuum, purged with argon, and charged with toluene (100 mL) as a solvent and propylene (5 g) as a monomer. After the reactor was heated to 40° C., triisobutylaluminum (1.0 mol/L, toluene solution) (0.5 mL, 0.5 mmol), [cyclooctanediyl-trans-1,2-bis(2-oxoyl-3,5-di-tert-butylbenzylsulfanyl)]dibenzylhafnium (1 μmol/mL, toluene solution) (0.02 mL, 0.02 μmol), and triphenylcarbenium tetrakis(pentafluorophenyl)borate (4.0 μmol/mL, toluene solution) (0.25 mL, 1.0 μmol) were added in turn to initiate polymerization. Polymerization was carried out for 60 minutes while the temperature was maintained at 40° C. to give an ethylene/propylene copolymer (0.18 g) with polymerization activity=9.0×10⁶ g/mol, Mw=3,500, and Mw/Mn=1.6.

### Example 6

A stirrer-equipped autoclave (internal volume 400 ml) was dried under vacuum, purged with argon, and charged with toluene (200 mL) as a solvent. After the reactor was heated to 70° C., ethylene was fed thereto while its partial pressure was adjusted to 0.6 MPa, and d-MAO (120 mg) and then [cyclooctanediyl-trans-1,2-bis(2-oxoyl-3,5-di-tert-butylbenzylsulfanyl)]dibenzylhafnium (1 μmol/mL, toluene solution) (0.10 mL, 0.10 μmol) were added to initiate polymerization. Polymerization was carried out for 60 minutes while the temperature was maintained at 70° C. to give an ethylenic polymer (2.86 g), with polymerization activity=2.9×10⁷ g/mol, melting point=131.3° C., Mw=17,700, and Mw/Mn=3.0.

### Example 7

A stirrer-equipped autoclave (internal volume 400 ml) was dried under vacuum, purged with argon, and charged with toluene (200 mL) as a solvent. After the reactor was heated to 100° C., ethylene was fed thereto while its partial pressure was adjusted to 0.6 MPa, and d-MAO (120 mg) and then [cyclooctanediyl-trans-1,2-bis(2-oxoyl-3,5-di-tert-butylbenzylsulfanyl)]dibenzylhafnium (1 μmol/mL, toluene solution) (0.10 mL, 0.10 μmol) were added to initiate polymerization. Polymerization was carried out for 60 minutes while the temperature was maintained at 100° C. to give an ethylenic polymer (3.60 g), with polymerization activity=3.6×10⁷ g/mol, melting point=127.4° C., Mw=5,000, and Mw/Mn=2.1.

### INDUSTRIAL APPLICABILITY

The present invention is useful in the field related to the production of the ethylenic polymer.

1. A catalyst for homopolymerization of ethylene or copolymerization of ethylene and an α-olefin, comprising a complex represented by Formula (1): 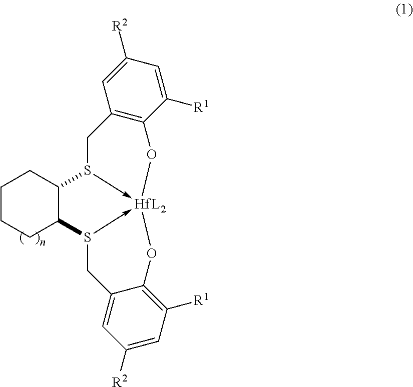
wherein n is 2 or 3;
R¹ and R² are independently an optionally substituted alkyl group or a halogen atom;
L is a ligand represented by CH₂R³, a halogen atom, OR⁴, or NR⁵R⁶;
R³ is a hydrogen atom, an aromatic group, or a trialkylsilyl group;
R⁴ is a lower alkyl group having 1 to 6 carbon atoms; and
R⁵ and R⁶ are independently a hydrogen atom or a lower alkyl group having 1 to 6 carbon atoms.

2. The catalyst according to claim 1, wherein n is 3.

3. The catalyst according to claim 1, wherein R¹ and R² are independently an optionally substituted alkyl group having 1 to 30 carbon atoms.

4. The catalyst according to claim 1, further comprising a boron compound or an organoaluminum compound as a co-catalyst.

5. The catalyst according to claim 4, wherein the boron compound is represented by BR¹¹R¹²R¹³, W⁺(BR¹¹R¹²R¹³R¹⁴)⁻, or (V-H)⁺(BR¹¹R¹²R¹³R¹⁴)⁻, wherein R11 to R14 are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms;
where R11 to R14 may be the same or different;
W+ is an inorganic or organic cation;
V is a neutral Lewis base; and
(V-H)+ is a Broensted acid.

6. The catalyst according to claim 4, wherein the organoaluminum compound is a cyclic aluminoxane and/or a linear aluminoxane.

7. A method for manufacturing an ethylenic polymer, comprising homopolymerization of ethylene or copolymerization of ethylene and an α-olefin in the presence of the catalyst according to claim 1.

8. The method according to claim 7, wherein the α-olefin is a monoolefin or a diolefin.

9. The method according to claim 8, wherein the monoolefin is at least one olefin selected from the group consisting of propylene, 1-butene, 1-pentene, 1-hexene, and 4-methyl-1-pentene.

10. The method according to claim 8, wherein the diolefin is at least one olefin selected from the group consisting of butadiene, 1,5-hexadiene, and 1,6-heptadiene.
